(19) United States
(12) Patent Application Publication
(10) Pub. No.: US 2018/0349575 A1
(43) Pub. Date: Dec. 6, 2018

(54) NATIVE CODE AUTHORIZATION VERIFICATION LIBRARY

(71) Applicant: INTEL CORPORATION, Santa Clara, CA (US)

(72) Inventors: Andrey Viktorovich SOMSIKOV, Nizhny Novgorod (RU); Roman Aleksandrovich KAZANTSEV, Moscow (RU)

(21) Appl. No.: 15/775,511

(22) PCT Filed: Dec. 4, 2015
(86) PCT No.: PCT/RU2015/000845

§ 371 Date: May 11, 2018

(51) Int. Cl. G06F 21/12; G06F 21/10; G06F 21/60; G06F 21/64; G06F 21/44; G06F 21/14; H04L 9/32; G06F 9/54; G06F 15/167

(52) U.S. Cl. CPC G06F 21/121; G06F 21/105; G06F 21/606; G06F 21/64; G06F 15/167; G06F 21/14; H04L 9/3242; G06F 9/544; G06F 9/546; G06F 21/44

(57) ABSTRACT

Disclosed in some examples are methods, machine readable mediums, and systems for protecting applications from unauthorized access. In some examples, this may be accomplished by implementing authorization verification tools that takes advantage of both managed code and native code. Native code is easier to protect from hackers as more advanced obfuscation tools may be utilized than with managed code. Once native code is compiled it is typically compiled into machine code instructions that are executed directly by a processor. These instructions are much harder to reverse engineer (e.g., decompile) and even if decompiled, are harder to modify.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright INTEL, All Rights Reserved.

### TECHNICAL FIELD

Embodiments pertain to security. Some embodiments relate to securing applications against unauthorized access.

### BACKGROUND

Software application developers have long battled with users who attempt to access their product in an unauthorized manner. Examples of unauthorized access include executing the application without a required license. Various authorization verification tools have been developed in order to thwart these attempts. Such verification tools are subject to attack themselves.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 shows a diagram of an authorization verification system according to some examples of the present disclosure.

FIG. 2 shows a diagram of an improved authorization verification system according to some examples of the present disclosure.

FIG. 3 shows a detailed diagram of an improved authorization verification system according to some examples of the present disclosure.

FIG. 4 shows a flowchart of a method of performing an authorization verification according to some examples of the present disclosure.

FIG. 5 shows a flowchart of a method of performing an authorization lookup on a trusted authorization server according to some examples of the present disclosure.

FIG. 6 is a block diagram illustrating an example of a machine upon which one or more embodiments may be implemented.

### DETAILED DESCRIPTION

Application developers may wish to place constraints to the utilization of their applications. Based on these constraints, developers may prohibit certain usages of the application by blocking features, functionality, or even execution of the entire application. Constraints may include one or more of: requiring the purchase or possession of a license to run all or part of the application, time-based constraints (e.g., the application, or certain features of the application are only active for certain time periods or during certain periods of time), location based constraints (e.g., the application, or certain features of the application are only active within certain locations), user based constraints (e.g., ensuring that only certain users of a device access the application, such as by authenticating), and the like. An application usage that obeys these constraints may be deemed an authorized use of the application. Application usage that does not obey these constraints may be deemed an unauthorized usage of the application.

Authorization verification tools are tools that application developers can utilize to enforce these constraints and ensure that only authorized users can execute an application or part of an application. Some authorization verification tools make use of managed code libraries that provide functionality for applications to check a user's authorization (e.g., a license status) with a trusted authorization server (e.g., a trusted licensing server). To use these authorization verification tools, an application developer includes the managed code libraries in the application package (e.g., an “.apk” file). These libraries are then called by the application code when needed to verify authorization status.

For example, to check a licensing status, an application calls functions provided by an authorization verification library to check the licensing status of the computing device on which the user is trying to run the application. The trusted authentication servers retrieve licensing details of the application for the particular device on which the application is running. The application then determines whether the licensing details satisfy the licensing constraints. Other types of authorization and constraint checking may function similarly. For example, for temporal constraints, the authorization verification library may contact the authorization server to determine whether the temporal constraints are satisfied. The temporal server may return back a yes or no answer, or may return a trusted time with which the application may determine whether the temporal constraints are satisfied. In still other examples, for geolocation-based constraints the authorization verification library may contact the authorization server to determine whether location based constraints have been satisfied. The request to the authorization verification library may include a device's current location, or may include information about the device that is then used by the authorization verification library to obtain the location of the device (e.g., from a cellular network provider). The location may then be returned to the device.

The trusted authorization server is a network-based server that stores data about and helps to validate application constraints. For example, for licensing constraints the trusted authorization server may return licensing details (e.g., whether the device or user is authorized, what level they are authorized to, and the like) to the application on the device. The application then uses the licensing details to determine whether the use of the application is to be allowed. One example of a managed code authorization library is the Licensing Verification Library (LVL) provided by GOOGLE® for applications running on its ANDROID® operating system. The LVL verifies licensing status for applications on ANDROID® through the GOOGLE® PLAY® application on the device. The authorization server is a GOOGLE® PLAY® server.

As previously discussed, these authorization verification libraries utilize managed code. Managed code relies upon an additional process at runtime or just before runtime that allows it to run on a particular platform—for example, Just In Time (JIT) compilation at run time, an interpreter (e.g., a Java run-time environment), or the like. In contrast, native code is compiled into machine executable format for direct execution on a particular platform. For example, code compiled specifically for devices running an ANDROID® operating system. One problem with the use of managed code libraries for license verification is that managed code is easy to decompile to its source code. Once a hacker decompiles the managed code libraries, the hackers may insert code that bypasses authorization checks.

To combat this, application developers have recently begun to turn to code obfuscation tools that intentionally turn source code into code that is much more difficult to understand. To bypass the authorization checks on obfuscated code, hackers have to figure out the obfuscated code in order to circumvent the authorization checks. These tools still leave clues that can allow a hacker to rewrite the code. For example, message strings (e.g., “Access Granted”) or certain methods like MessageBox and Show( ) are typically not obfuscated. These unobfuscated code portions may give a hacker the contextual clues they need to modify the portion of the code that controls access.

Disclosed in some examples are methods, machine-readable mediums, and systems for protecting applications from unauthorized access. In some examples, this may be accomplished by implementing authorization verification tools that takes advantage of both managed code and native code. Native code is easier to protect from hackers as more advanced obfuscation tools may be utilized than with managed code. Once native code is compiled it is typically compiled into machine code instructions that are executed directly by a processor. These instructions are much harder to reverse engineer (e.g., decompile) and even if decompiled, are harder to modify.

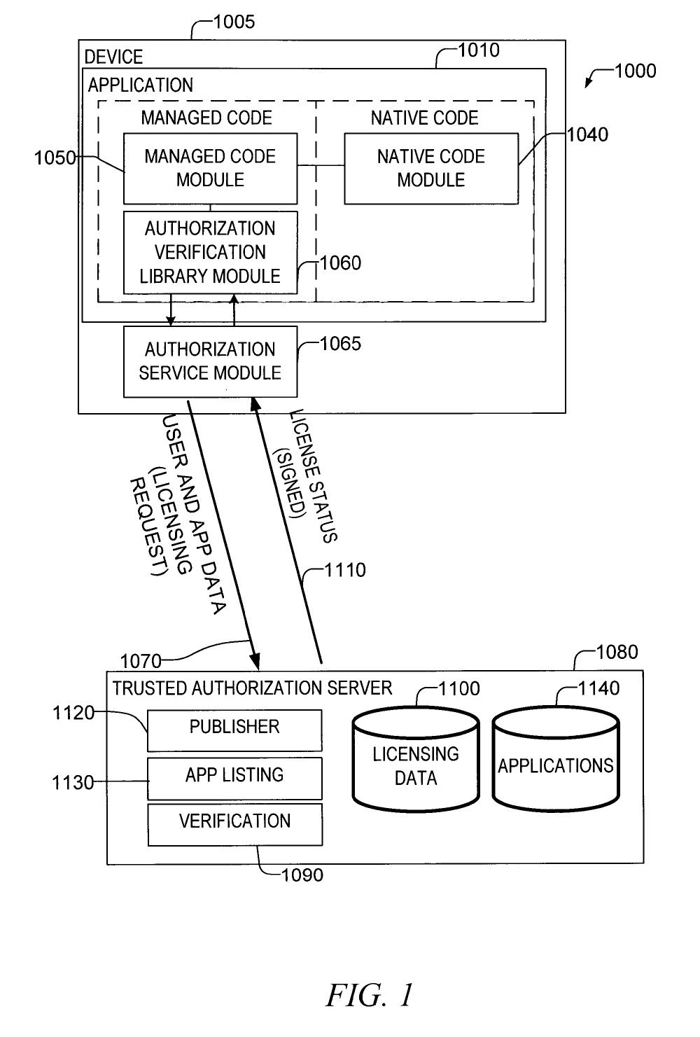

Turning now to FIG. 1, a diagram of an authorization verification system 1000 is shown according to some examples of the present disclosure. Application 1010 may execute on one or more computing devices 1005, such as a mobile device (e.g., a smartphone, tablet, laptop computer, desktop computer, or the like). Application 1010 comprises both managed code and native code. Native code module 1040 comprises one or more portions of the application code that is in a native format. Managed code module 1050 comprises the portion of code that is in a managed code format. Application 1010's managed code also includes authorization verification library module 1060. Managed code module 1050 interacts with authorization verification library module 1060 to verify that the application 1010 is authorized before allowing the application 1010, or a portion of the application 1010, to execute or continue executing to provide the corresponding functions of the application (e.g., a gaming application, a productivity application, and the like).

In the case of FIG. 1, authorization verification library module 1060 verifies a licensing status of device 1005 to determine that application 1010 is authorized. For example, authorization verification library module 1060 implements a number of functions that, when called by managed code module 1050, sends data comprising one or more of user, device and application data in a licensing request 1070 over a network to trusted authorization server 1080. Trusted authorization server 1080 determines a license status of the device. Verification module 1090 of trusted authorization server 1080 looks up the application in a licensing database 1100 using the application data included in licensing request 1070 and determines a licensing status of the device 1005 (or a user of the device) from licensing database 1100. In some examples, device 1005 may be uniquely identified using one or more unique identification numbers (e.g., a UUID).

In some examples, the license may be per-device—that is, all users of the device are licensed to use the application. In other examples, the license may be per-user where only certain users may be licensed. And in yet other examples, the license may be per-user and per-device, that is, only certain users are licensed on certain devices. In examples in which the license is per-device, the authorization verification library module 1060 may send a unique identifier of the device 1005 to the trusted authorization service 1080. In other examples, where licensing is per-user, the authorization verification library module 1060 may send information (e.g., credentials) about the user trying to access the application 1010. In examples in which the licensing is per-user-per-device, the authorization verification library module 1060 may send both a device and user identifier.

The licensing status is returned in license status message 1110 to authorization verification library module 1060, which then communicates that information to managed code module 1050. In some examples, this happens through a callback function in managed code module 1050 that is registered with authorization verification library module 1060. In some examples, authorization verification library module 1060 communicates with trusted authorization server 1080 by issuing a command to an authorization service module 1065 which may then handle the communications with trusted authorization server 1080. Authorization service module 1065 may be a separate application, an operating system service, or a module within another application.

Trusted authorization server 1080 may have a publisher module 1120 which allows developers to upload applications to trusted authorization server 1080. The process of publishing an application may include one or more quality assurance checks, application registration, entering licensing terms such as price and duration of the license, and the like. Application listing module 1130 may create one or more network-based application “stores” with which users may connect, obtain licenses for, and download one or more applications that were published by developers through publisher module 1120. Applications uploaded by publisher module 1120 and provided by the application listing module 1130 may be stored in an applications database 1140.

The managed code portions of the application 1010 are easily decompiled and may be modified by an unscrupulous individual. This individual may then post the modified version of the application online where others may download it and use the software in an unauthorized manner. Worse yet, the unscrupulous individual may plant malware or other undesirable code, tricking others into believing it's a legitimate version and destroying the reputation of the application developer.

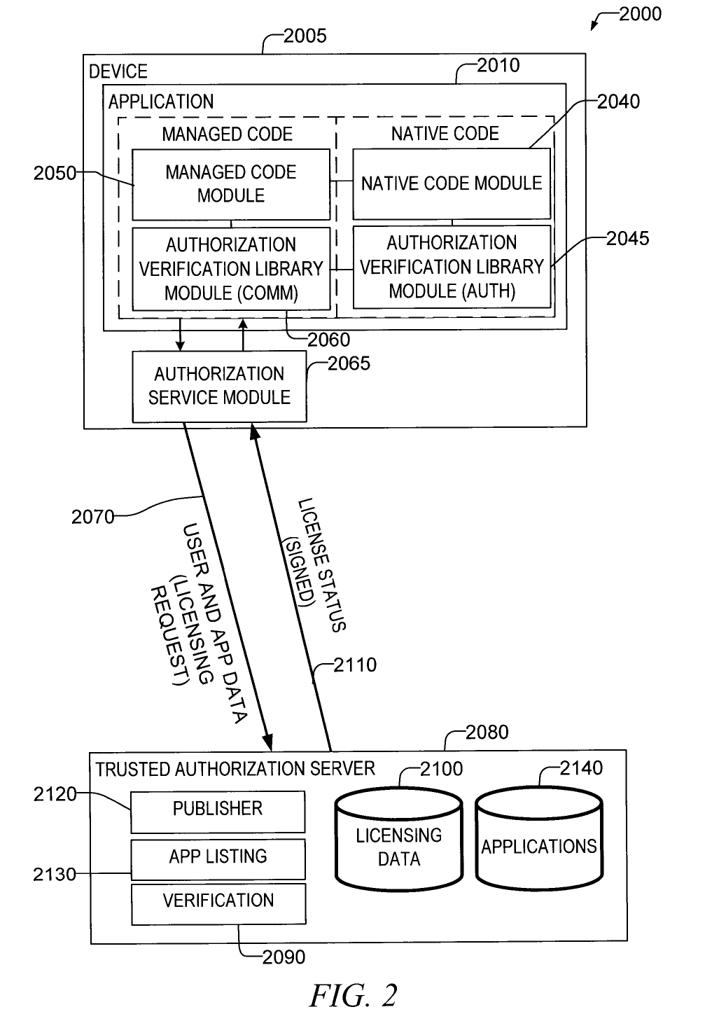

Turning now to FIG. 2, a diagram of an improved authorization verification system 2000 is shown according to some examples of the present disclosure. Application 2010 may execute on one or more computing devices 2005, such as a mobile device (e.g., a smartphone, tablet, laptop computer, or the like). Application 2010 comprises both managed code and native code. Native code module 2040 comprises the portion of the application code that is in a native format. Managed code module 2050 comprises the portion of code that is in a managed code format.

In FIG. 2, authorization verification library module is split into two parts. One part, authorization verification library module (communications) 2060 is managed code. The other part, the authorization verification library module (authorization context) 2045 is native code. Authorization verification library module (communications) 2060 provides library functions that are resident in managed code portions of the application and handle communications with trusted authorization server 2080 (in some examples via authorization service module 2065). These functions include gathering user, device, and application information, forming a licensing request 2070, sending the request, receiving licensing status 2110, and generating a callback to the callback function of the application to pass back the licensing status to the application.

Authorization verification library module (authorization context) 2045 may contain code which initializes, queries, and sets an authorization context for an application. In some examples, for licensing based authorization, the authorization context may be a licensing context. In these cases, the authorization verification library module (authorization context) 2045 may set the authorization context based upon information about the licensing status obtained by authorization and verification library module (communications) 2060. Authorization verification library module (authorization context) 2045 may have code that stores and retrieves the licensing status and passes this status to native code module 2040 which makes decisions about whether to continue executing application 2010 based upon the licensing status. For example, if device 2005 or the user of the device is not licensed, the native code module 2040 may perform an unauthorized device or user function. Example unauthorized device or user functions include one or more of: terminating execution of the application, displaying a message, taking the user to an app listing page for the application on trusted authorization server 2080 to purchase a license, or take any other action desired. In some examples, the evaluation of the license status 2110 may be done in native code module 2040, but in other examples, authorization verification library module (authorization context) 2045 may verify that the use of application 2010 is authorized and licensed based upon licensing constraints communicated to authorization verification library module (authorization context) 2045 by the application 2010, or by the application's use of overloaded functions of authorization verification library module (authorization context) 2045.

Trusted authorization server 2080 may include verification module 2090 that looks up the application in a licensing database 2100 using the application data included in licensing request 2070 and determines a licensing status of the device 2005 (or a user of the device) from licensing database 2100. This licensing status may be returned in licensing status 2110. In addition to providing authorization services, trusted authorization server 2080 may have a publisher module 2120 which allows developers to upload applications to trusted authorization server 2080. The publishing process may include one or more quality assurance checks, application registration, entering licensing terms such as price and duration of the license, and the like. Application listing module 2130 may create one or more network-based application “stores” with which users may connect, obtain licenses, and download one or more applications that were uploaded by developers through publisher module 2120. Applications uploaded by publisher module 2120 and provided by application listing module 2130 may be stored in an applications database 2140.

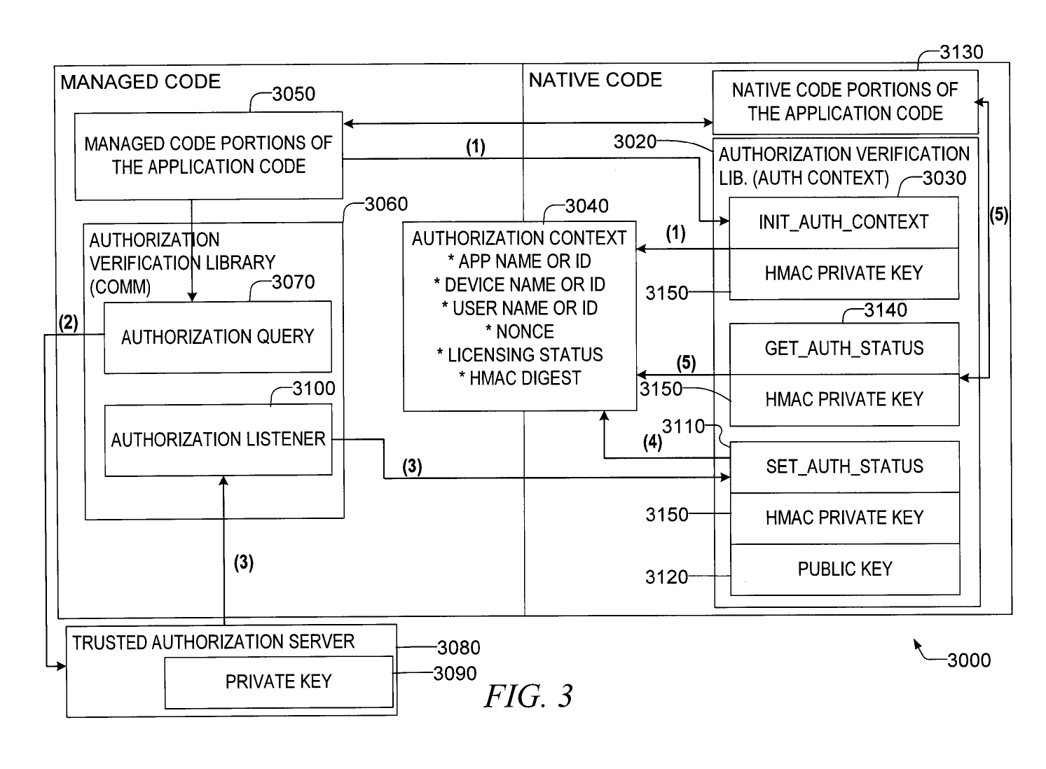

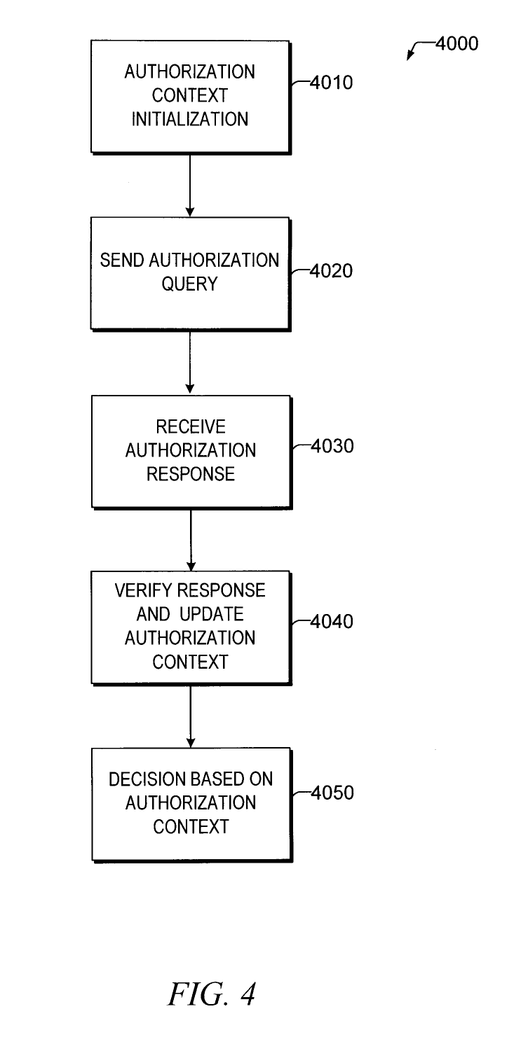

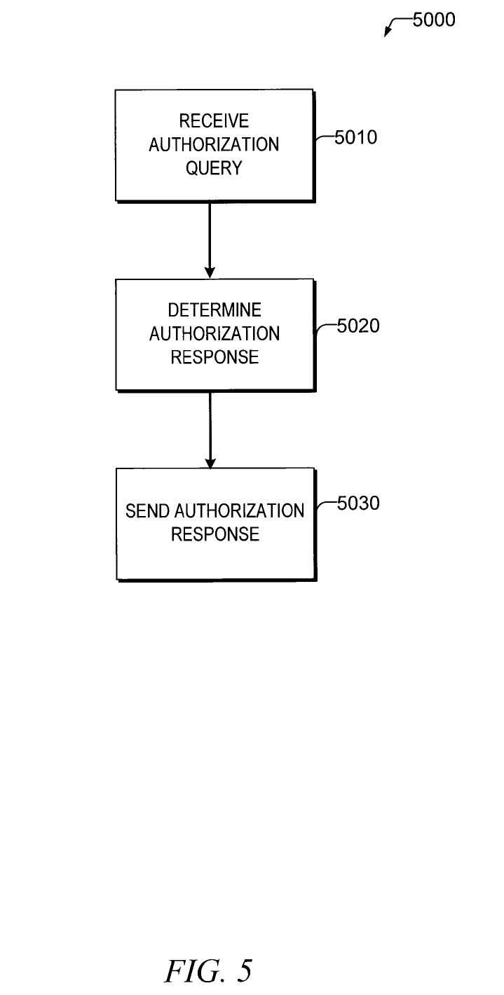

Turning now to FIG. 3, a detailed diagram of an improved authorization verification system 3000 is shown according to some examples of the present disclosure. FIG. 3 presents additional details of the system of FIG. 2. FIG. 3 will be discussed in conjunction with FIGS. 4 and 5. FIG. 4 shows a flowchart of a method of performing authorization verification according to some examples of the present disclosure. FIG. 5 shows a flowchart of a method of performing an authorization lookup on a trusted authorization server according to some examples of the present disclosure. At operation 4010 managed code portions of application code module 3050 calls an initialize_authorization_context function 3030 of authorization verification library (authorization context) module 3020. This function initializes an authorization context 3040. Authorization context 3040 may be stored as a data structure in memory (volatile or non-volatile) of the computing device. Authorization context 3040 may store information needed to authorize the application. In some examples, this includes licensing information such as a licensing status and contextual information such as one or more of: the application name or id, user name or id, device name or id, nonce, and licensing status. An initialize_authorization_context function 3030 initializes the authorization context with one or more of the application name or id, device name or id, user names or ids. The function also generates and stores in the authorization context a nonce, initializes the license state to unlicensed, and computes a keyed-hash message authentication code (HMAC) digest using an HMAC function. The inputs to the HMAC function include the initialized authorization context 3040 and the HMAC private key 3150.

HMAC is a specific construction for calculating a message authentication code (MAC) involving a cryptographic hash function in combination with a secret cryptographic key. Example cryptographic hash functions include MD5 and SHA-1. One implementation of HMAC is defined by the Internet Engineering Task Force (IETF) Request for Comment (RFC) 2014.

The integrity of the authorization context 3040 can be verified by any module possessing HMAC private key 3150. HMAC private key 3150 is a cryptographic key used in an encryption algorithm. The module calculates that HMAC digest of the authorization context 3040 using the values of the authorization context 3040, the HMAC function, and HMAC private key 3150. If the calculated HMAC digest matches the HMAC digest stored with authorization context 3040, then authorization context 3040 is valid. Otherwise, authorization context 3040 is not valid and tampering is indicated.

Any time an authorized change is made, HMAC digest value is updated using the HMAC function, HMAC private key 3150, and the new values of authorization context 3040. In the example of FIG. 3, any time a change is made to authorization context 3040 by any of the authorization verification library (authorization context) module 3020 functions, the HMAC digest is recalculated and the new HMAC is stored. Additionally, when the authorization context 3040 is accessed (after the initialization), the integrity of the authorization context 3040 is verified. This protects authorization context 3040 from changes that were not made by functions of the authorization verification library (authorization context) module 3020. If hackers were to change any information in authorization context 3040, the HMAC digest associated with authorization context 3040 would not match the HMAC digest calculated by functions of the authorization verification library (authorization context) module 3020. The authorization verification library (authorization context) module 3020 may deem tampering to be an unauthorized access and perform an unauthorized device function.

At operation 4020, the application sends an authorization query (e.g., a licensing request) to the trusted authorization server 3080 to obtain an authorization status. Managed code portions of application code module 3050 calls an authorization_query_function 3070 of authorization verification library (communications) module 3060 in the managed code portion of the application. Authorization_query_function 3070 contacts a trusted authorization server 3080. In some examples, it uses an intermediary service (such as an authorization service module—not shown for clarity). In some examples, the request includes context data include application names or ids, user names or ids, device name or id, other device information, a nonce, and the like.

Turning now to FIG. 5, the trusted authorization server 3080 receives the authorization query at operation 5010. At operation 5020 the trusted authorization server 3080 determines the authorization status for the given information (e.g., for a given user or device). For example, a response may include licensing information, such as the application name, user name, nonce, and license status. In other examples, other constraints may include other information in the response. For example, for temporal constraints, the response may include an indication as to whether the execution of the application (or a part of the application) meets the temporal constraints. In another example, the response may have a trusted time that is used by the application itself to determine whether the constraints are satisfied. The response from the authorization server may be signed with one of a pair of cryptographic keys 3090 (e.g., an RSA® private key) of the application vendor which may be created by the trusted authorization server 3080 during application publication. The corresponding other key may be provided to the application by the application vendor and used to verify the signature. The response is sent at operation 5030 to the requesting device.

Turning back to FIG. 4, the device receives the authorization response at operation 4030. The response is handled by an authorization_listener_function 3100 of authorization verification library (communications) module 3060. Authorization listener function 3100 calls the set_authorization_status function 3110 of authorization verification library (authorization context) module 3020 of the native code portion, passing in the response received from trusted authorization server 3080.

At operation 4040, using the other one of the pair of cryptographic keys 3120 (e.g., a public key), set_authorization_status function 3110 verifies the integrity of the response from trusted authorization server 3080 using the corresponding one of the pair of cryptographic keys. Set_authorization_status function 3110 verifies that the message is from trusted authorization server 3080 by matching the nonce in the message with the expected nonce sent to trusted authorization server 3080. If the message is from trusted authorization server 3080, the set_authorization_status function 3110 verifies that the value of the fields (user name, nonce, and application name) in the authorization context 3040 matches the expected values. If these values match, set_authorization_status function 3110 updates authorization context 3040 with the information sent from trusted authorization server 3080 in the response. For example, the licensing status from the response sent by trusted authorization server 3080 may be stored in the authorization context 3040. Prior to updating the authorization context 3040 with the new authorization information, set_authorization_status function 3110 may also re-verify the integrity of authorization context 3040 by calculating an HMAC digest (as described above) and comparing it to the stored HMAC digest. If the calculated HMAC digest matches the stored HMAC digest, then the integrity is validated. If the calculated HMAC digest does not match the stored HMAC digest, tampering is indicated and action may be taken (such as terminating the application, throwing an error message or exception, or the like). Once the current authorization context is verified, the set_authorization_status function 3110 may update the licensing status of authorization context 3040, recalculate the HMAC digest using the new value of authorization context 3040, and store the recalculated HMAC digest.

At operation 4050, native code portions of the application 3130 calls a get_authorization_status function 3140 of authorization verification library (authorization context) module 3020 that resides in native code portion of the application. Get_authorization_status function 3140 determines whether the current user or device is authorized. Using HMAC private key 3150 that was initialized by initialize_authorization_context function 3030, get_authorization_status function 3140 verifies that authorization context 3040 is not corrupted or modified inappropriately (as described above). Get_authorization_status function 3140 then returns the authorization status to the native code portions of the application 3130 that may either allow or disallow further application execution, or may take other actions depending on the results including unauthorized device or user functions.

This solution is resistant to common attacks. For example, authorization context 3040 can be restricted to only be updatable by native functions initialize_authorization_context function 3030, get_authorization_status 3140, and set_authorization_status 3110 because they are the only functions with access to HMAC private key 3150 and therefore are the only functions able to recalculate the HMAC digest. Moreover, these native functions and the keys may be protected against tampering and reverse engineering by native code obfuscation, which is more robust than managed code obfuscation. Native code obfuscation may also be applied to some of the native code portions of the application 3130 which call get_authorization_status function 3140 to make it more difficult for attackers to remove license check points. In some examples, the obfuscation compiler, such as the Intel® Tamper Protection Toolkit produces code which is self-encrypted at run-time and protected against tampering and reverse engineering.

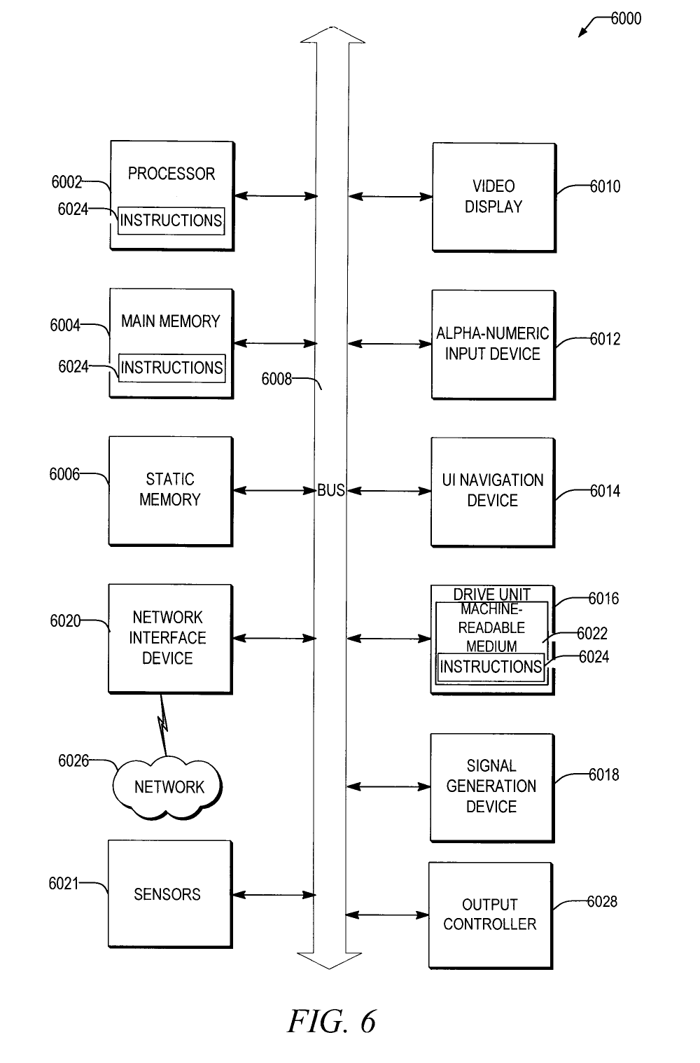

FIG. 6 illustrates a block diagram of an example machine 6000 upon which any one or more of the techniques (e.g., methodologies) discussed herein may perform. In alternative embodiments, the machine 6000 may operate as a standalone device or may be connected (e.g., networked) to other machines. In a networked deployment, the machine 6000 may operate in the capacity of a server machine, a client machine, or both in server-client network environments. In an example, the machine 6000 may act as a peer machine in peer-to-peer (P2P) (or other distributed) network environment. The machine 6000 may be a personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 6000 may include a hardware processor 6002 (e.g., a central processing unit (CPU), a graphics processing unit (GPU), a hardware processor core, or any combination thereof), a main memory 6004 and a static memory 6006, some or all of which may communicate with each other via an interlink (e.g., bus) 6008. The machine 6000 may further include a display unit 6010, an alphanumeric input device 6012 (e.g., a keyboard), and a user interface (UI) navigation device 6014 (e.g., a mouse). In an example, the display unit 6010, input device 6012 and UI navigation device 6014 may be a touch screen display. The machine 6000 may additionally include a storage device (e.g., drive unit) 6016, a signal generation device 6018 (e.g., a speaker), a network interface device 6020, and one or more sensors 6021, such as a global positioning system (GPS) sensor, compass, accelerometer, or other sensor. The machine 6000 may include an output controller 6028, such as a serial (e.g., universal serial bus (USB), parallel, or other wired or wireless (e.g., infrared(IR), near field communication (NFC), etc.) connection to communicate or control one or more peripheral devices (e.g., a printer, card reader, etc.).

The storage device 6016 may include a machine readable medium 6022 on which is stored one or more sets of data structures or instructions 6024 (e.g., software) embodying or utilized by any one or more of the techniques or functions described herein. The instructions 6024 may also reside, completely or at least partially, within the main memory 6004, within static memory 6006, or within the hardware processor 6002 during execution thereof by the machine 6000. In an example, one or any combination of the hardware processor 6002, the main memory 6004, the static memory 6006, or the storage device 6016 may constitute machine readable media. The instructions in machine readable medium 6022 may include native instructions and managed instructions. Both native and managed instructions cause the machine 6000 to perform certain operations, including for example, the operations of FIG. 4 or 5. As disclosed previously, native instructions are instructions that are in a form for execution on a particular platform. Managed instructions rely upon an additional process at runtime or just before runtime that allows it to run on a particular platform—for example, Just In Time (JIT) compilation at run time, an interpreter (e.g., a Java run-time environment), or the like. These instructions may be translated or converted into instructions that are in a form for execution on a particular platform.

While the machine readable medium 6022 is illustrated as a single medium, the term “machine readable medium” may include a single medium or multiple media (e.g., a centralized or distributed database, and/or associated caches and servers) configured to store the one or more instructions 6024.

The term “machine readable medium” may include any medium that is capable of storing, encoding, or carrying instructions for execution by the machine 6000 and that cause the machine 6000 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine readable media. In some examples, machine readable media may include machine readable media that is not a transitory propagating signal.

The instructions 6024 may further be transmitted or received over a communications network 6026 using a transmission medium via the network interface device 6020. The Machine 6000 may communicate with one or more other machines utilizing any one of a number of transfer protocols (e.g., frame relay, Internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 6020 may include one or more physical jacks (e.g., Ethernet, coaxial, or phone jacks) or one or more antennas to connect to the communications network 6026. In an example, the network interface device 6020 may include a plurality of antennas to wirelessly communicate using at least one of single-input multiple-output (SIMO), multiple-input multiple-output (MIMO), or multiple-input single-output (MISO) techniques. In some examples, the network interface device 6020 may wirelessly communicate using Multiple User MIMO techniques.

### OTHER NOTES AND EXAMPLES

Example 1 is a non-transitory machine readable medium that stores instructions which when performed by a machine, cause the machine to perform operations comprising: querying, over a network, an authorization server for an authorization status of an application, the instructions for querying being managed instructions; receiving an authorization status response from the authorization server; responsive to receiving the authorization status response from the authorization server, updating an authorization context with the authorization status, the instructions for updating the authorization context being native instructions; and determining that the application is not authorized based upon the authorization status stored in the authorization context, and in response, performing an unauthorized device function, the instructions for determining being native instructions.

In Example 2, the subject matter of Example 1 optionally includes, wherein the authorization status comprises a licensing status and wherein the operations of determining that the application is not authorized based upon the authorization status comprises determining that the application is not licensed.

In Example 3, the subject matter of any one or more of Examples 1-2 optionally include, wherein the operations comprise initializing the authorization context by calculating a keyed hash message authentication code (HMAC) digest value based upon a private cryptographic key and the authorization context.

In Example 4, the subject matter of Example 3 optionally includes, wherein the operations of determining that the application is not authorized comprises: verifying the HMAC digest value by matching the HMAC digest value with an HMAC digest value that is calculated based upon the private cryptographic key and the authorization context; and determining that the authorization status stored in the authorization context indicates that the device is not authorized to run the application.

In Example 5, the subject matter of any one or more of Examples 1-4 optionally include, wherein the operations of performing the unauthorized device function comprises terminating further execution of the application.

In Example 6, the subject matter of any one or more of Examples 1-5 optionally include, wherein the native instructions are obfuscated using a code obfuscation tool.

In Example 7, the subject matter of any one or more of Examples 1-6 optionally include, wherein the authorization status received from the authorization server is signed with a first cryptographic key corresponding to the application, and wherein receiving the authorization status comprises verifying the authorization status using a second cryptographic key corresponding to the application and the first cryptographic key, the instructions for verifying the authorization status being native instructions.

In Example 8, the subject matter of any one or more of Examples 1-7 optionally include, wherein the instructions for querying the authorization server, receiving an authorization status, and updating the authorization context are implemented as a library.

In Example 9, the subject matter of any one or more of Examples 1-8 optionally include, wherein the authorization context is stored as a data structure in memory of the machine.

In Example 10, the subject matter of any one or more of Examples 1-9 optionally include, wherein the operations of querying, over the network, the authorization server and receiving the authorization status from the authorization server comprises the operations of communicating with an authorization service executing on the machine.

Example 11 is a device, comprising: a computer processor; a non-transitory memory, that stores instructions of an application, which when performed by the computer processor, cause the device to perform operations comprising: querying, over a network, an authorization server for an authorization status of an application, the instructions for querying being managed instructions; receiving an authorization status response from the authorization server; responsive to receiving the authorization status response from the authorization server, updating an authorization context with the authorization status, the instructions for updating the authorization context being native instructions; and determining that the application is not authorized based upon the authorization status stored in the authorization context, and in response, performing an unauthorized device function, the instructions for determining being native instructions.

In Example 12, the subject matter of Example 11 optionally includes, wherein the authorization status comprises a licensing status and wherein the operations of determining that the application is not authorized based upon the authorization status comprises determining that the application is not licensed.

In Example 13, the subject matter of any one or more of Examples 11-12 optionally include, wherein the operations comprise initializing the authorization context by calculating a keyed hash message authentication code (HMAC) digest value based upon a private cryptographic key and the authorization context.

In Example 14, the subject matter of Example 13 optionally includes, wherein the operations of determining that the application is not authorized comprises: verifying the HMAC digest value by matching the HMAC digest value with an HMAC digest value that is calculated based upon the private cryptographic key and the authorization context; and determining that the authorization status stored in the authorization context indicates that the device is not authorized to run the application.

In Example 15, the subject matter of any one or more of Examples 11-14 optionally include, wherein the operations of performing the unauthorized device function comprises terminating further execution of the application.

In Example 16, the subject matter of any one or more of Examples 11-15 optionally include, wherein the native instructions are obfuscated using a code obfuscation tool.

In Example 17, the subject matter of any one or more of Examples 11-16 optionally include, wherein the authorization status received from the authorization server is signed with a first cryptographic key corresponding to the application, and wherein receiving the authorization status comprises verifying the authorization status using a second cryptographic key corresponding to the application and the first cryptographic key, the instructions for verifying the authorization status being native instructions.

In Example 18, the subject matter of any one or more of Examples 11-17 optionally include, wherein the instructions for querying the authorization server, receiving an authorization status, and updating the authorization context are implemented as a library.

In Example 19, the subject matter of any one or more of Examples 11-18 optionally include, wherein the authorization context is stored as a data structure in memory of the machine.

In Example 20, the subject matter of any one or more of Examples 11-19 optionally include, wherein the operations of querying, over the network, the authorization server and receiving the authorization status from the authorization server comprises the operations of communicating with an authorization service executing on the machine.

Example 21 is a method comprising: using a computer processor: querying, over a network, an authorization server for an authorization status of an application, the querying being done using managed instructions; receiving an authorization status response from the authorization server; responsive to receiving the authorization status response from the authorization server, updating an authorization context with the authorization status, the updating the authorization context being done using native instructions; and determining that the application is not authorized based upon the authorization status stored in the authorization context, and in response, performing an unauthorized device function, the instructions for determining being done using native instructions.

In Example 22, the subject matter of Example 21 optionally includes, wherein the authorization status comprises a licensing status and wherein determining that the application is not authorized based upon the authorization status comprises determining that the application is not licensed.

In Example 23, the subject matter of any one or more of Examples 21-22 optionally include initializing the authorization context by calculating a keyed hash message authentication code (HMAC) digest value based upon a private cryptographic key and the authorization context.

In Example 24, the subject matter of Example 23 optionally includes, wherein determining that the application is not authorized comprises: verifying the HMAC digest value by matching the HMAC digest value with an HMAC digest value that is calculated based upon the private cryptographic key and the authorization context; and determining that the authorization status stored in the authorization context indicates that the device is not authorized to run the application.

In Example 25, the subject matter of any one or more of Examples 21-24 optionally include, wherein performing the unauthorized device function comprises terminating further execution of the application.

In Example 26, the subject matter of any one or more of Examples 21-25 optionally include, wherein the native instructions are obfuscated using a code obfuscation tool.

In Example 27, the subject matter of any one or more of Examples 21-26 optionally include, wherein the authorization status received from the authorization server is signed with a first cryptographic key corresponding to the application, and wherein receiving the authorization status comprises verifying the authorization status using a second cryptographic key corresponding to the application and the first cryptographic key.

In Example 28, the subject matter of any one or more of Examples 21-27 optionally include, wherein querying the authorization server, receiving an authorization status, and updating the authorization context are performed using a library.

In Example 29, the subject matter of any one or more of Examples 21-28 optionally include, wherein the authorization context is stored as a data structure in memory of the machine.

In Example 30, the subject matter of any one or more of Examples 21-29 optionally include, wherein querying, over the network, the authorization server and receiving the authorization status from the authorization server comprises communicating with an authorization service executing on the machine.

Example 31 is a device comprising: means for querying, over a network, an authorization server for an authorization status of an application, the querying being done using managed instructions; means for receiving an authorization status response from the authorization server; means for updating an authorization context with the authorization status responsive to receiving the authorization status response from the authorization server, the updating the authorization context being done using native instructions; and means for determining that the application is not authorized based upon the authorization status stored in the authorization context, and in response, means for performing an unauthorized device function, the instructions for determining being done using native instructions.

In Example 32, the subject matter of Example 31 optionally includes, wherein the authorization status comprises a licensing status and wherein means for determining that the application is not authorized based upon the authorization status comprises means for determining that the application is not licensed.

In Example 33, the subject matter of any one or more of Examples 31-32 optionally include means for initializing the authorization context by calculating a keyed hash message authentication code (HMAC) digest value based upon a private cryptographic key and the authorization context.

In Example 34, the subject matter of Example 33 optionally includes, wherein means for determining that the application is not authorized comprises: means for verifying the HMAC digest value by matching the HMAC digest value with an HMAC digest value that is calculated based upon the private cryptographic key and the authorization context; and means for determining that the authorization status stored in the authorization context indicates that the device is not authorized to run the application.

In Example 35, the subject matter of any one or more of Examples 31-34 optionally include, wherein means for performing the unauthorized device function comprises means for terminating further execution of the application.

In Example 36, the subject matter of any one or more of Examples 31-35 optionally include, wherein the native instructions are obfuscated using a code obfuscation tool.

In Example 37, the subject matter of any one or more of Examples 31-36 optionally include, wherein the authorization status received from the authorization server is signed with a first cryptographic key corresponding to the application, and wherein means for receiving the authorization status comprises means for verifying the authorization status using a second cryptographic key corresponding to the application and the first cryptographic key.

In Example 38, the subject matter of any one or more of Examples 31-37 optionally include, wherein means for querying the authorization server, means for receiving an authorization status, and means for updating the authorization context are performed using a library.

In Example 39, the subject matter of any one or more of Examples 31-38 optionally include, wherein the authorization context is stored as a data structure in memory of the device.

In Example 40, the subject matter of any one or more of Examples 31-39 optionally include, wherein means for querying, over the network, the authorization server and means for receiving the authorization status from the authorization server comprises means for communicating with an authorization service executing on the device.

1.-25. (canceled)

26. A non-transitory machine readable medium that stores instructions which when performed by a machine, cause the machine to perform operations comprising:
querying, over a network, an authorization server for an authorization status of an application, the instructions for querying being managed instructions;
receiving an authorization status response from the authorization server;
responsive to receiving the authorization status response from the authorization server, updating an authorization context with the authorization status, the instructions for updating the authorization context being native instructions; and
determining that the application is not authorized based upon the authorization status stored in the authorization context, and in response, performing an unauthorized device function, the instructions for determining being native instructions.

27. The machine readable medium of claim 26, wherein the authorization status comprises a licensing status and wherein the operations of determining that the application is not authorized based upon the authorization status comprises determining that the application is not licensed.

28. The machine readable medium of claim 26, wherein the operations comprise initializing the authorization context by calculating a keyed hash message authentication code (HMAC) digest value based upon a private cryptographic key and the authorization context.

29. The machine readable medium of claim 28, wherein the operations of determining that the application is not authorized comprises:
verifying the HMAC digest value by matching the HMAC digest value with an HMAC digest value that is calculated based upon the private cryptographic key and the authorization context; and
determining that the authorization status stored in the authorization context indicates that the device is not authorized to run the application.

30. The machine readable medium of claim 26, wherein the operations of performing the unauthorized device function comprises terminating further execution of the application.

31. The machine readable medium of claim 26, wherein the native instructions are obfuscated using a code obfuscation tool.

32. The machine readable medium of claim 26, wherein the authorization status received from the authorization server is signed with a first cryptographic key corresponding to the application, and wherein receiving the authorization status comprises verifying the authorization status using a second cryptographic key corresponding to the application and the first cryptographic key, the instructions for verifying the authorization status being native instructions.

33. The machine readable medium of claim 26, wherein the instructions for querying the authorization server, receiving an authorization status, and updating the authorization context are implemented as a library.

34. The machine readable medium of claim 26, wherein the authorization context is stored as a data structure in memory of the machine.

35. The machine readable medium of claim 26, wherein the operations of querying, over the network, the authorization server and receiving the authorization status from the authorization server comprises the operations of communicating with an authorization service executing on the machine.

36. A device, comprising:
a computer processor;
a non-transitory memory, that stores instructions of an application, which when performed by the computer processor, cause the device to perform operations comprising:
querying, over a network, an authorization server for an authorization status of an application, the instructions for querying being managed instructions;
receiving an authorization status response from the authorization server;
responsive to receiving the authorization status response from the authorization server, updating an authorization context with the authorization status, the instructions for updating the authorization context being native instructions; and
determining that the application is not authorized based upon the authorization status stored in the authorization context, and in response, performing an unauthorized device function, the instructions for determining being native instructions.

37. The device of claim 35, wherein the authorization status comprises a licensing status and wherein the operations of determining that the application is not authorized based upon the authorization status comprises determining that the application is not licensed.

38. The device of claim 35, wherein the operations comprise initializing the authorization context by calculating a keyed hash message authentication code (HMAC) digest value based upon a private cryptographic key and the authorization context.

39. The device of claim 38, wherein the operations of determining that the application is not authorized comprises:
verifying the HMAC digest value by matching the HMAC digest value with an HMAC digest value that is calculated based upon the private cryptographic key and the authorization context; and
determining that the authorization status stored in the authorization context indicates that the device is not authorized to run the application.

40. The device of claim 35, wherein the operations of performing the unauthorized device function comprises terminating further execution of the application.

41. The device of claim 35, wherein the native instructions are obfuscated using a code obfuscation tool.

42. The device of claim 35, wherein the authorization status received from the authorization server is signed with a first cryptographic key corresponding to the application, and wherein receiving the authorization status comprises verifying the authorization status using a second cryptographic key corresponding to the application and the first cryptographic key, the instructions for verifying the authorization status being native instructions.

43. The device of claim 35, wherein the instructions for querying the authorization server, receiving an authorization status, and updating the authorization context are implemented as a library.

44. The device of claim 35, wherein the authorization context is stored as a data structure in memory of the machine.

45. The device of claim 35, wherein the operations of querying, over the network, the authorization server and receiving the authorization status from the authorization server comprises the operations of communicating with an authorization service executing on the machine.

46. A method comprising:
using a computer processor:
querying, over a network, an authorization server for an authorization status of an application, the querying being done using managed instructions;
receiving an authorization status response from the authorization server;
responsive to receiving the authorization status response from the authorization server, updating an authorization context with the authorization status, the updating the authorization context being done using native instructions; and
determining that the application is not authorized based upon the authorization status stored in the authorization context, and in response, performing an unauthorized device function, the instructions for determining being done using native instructions.

47. The method of claim 46, wherein the authorization status comprises a licensing status and wherein determining that the application is not authorized based upon the authorization status comprises determining that the application is not licensed.

48. The method of claim 46, comprising initializing the authorization context by calculating a keyed hash message authentication code (HMAC) digest value based upon a private cryptographic key and the authorization context.

49. The method of claim 48, wherein determining that the application is not authorized comprises:
verifying the HMAC digest value by matching the HMAC digest value with an HMAC digest value that is calculated based upon the private cryptographic key and the authorization context; and
determining that the authorization status stored in the authorization context indicates that the device is not authorized to run the application.

50. The method of claim 46, wherein performing the unauthorized device function comprises terminating further execution of the application.
